(19) United States
(12) Patent Application Publication
(10) Pub. No.: US 2026/0230626 A1
(43) Pub. Date: Aug. 6, 2026

(54) Merge Mode With Motion Vector Difference Based Subblock-Based Temporal Motion Vector Prediction

(71) Applicant: Google LLC, Mountain View, CA (US)

(72) Inventors: Xiang Li, Saratoga, CA (US); Yaowu Xu, Saratoga, CA (US); Debargha Mukherjee, Cupertino, CA (US); Jingning Han, Santa Clara, CA (US)

(21) Appl. No.: 19/142,898

(22) PCT Filed: Jan. 11, 2024
(86) PCT No.: PCT/US2024/011138

§ 371 Date: Jun. 24, 2025

Related U.S. Application Data
(60) Provisional application No. 63/438,782, filed on Jan. 12, 2023.

(51) Int. Cl. H04N 19/139; H04N 19/119; H04N 19/176; H04N 19/70

(52) U.S. Cl. CPC H04N 19/139; H04N 19/119; H04N 19/176; H04N 19/70

(57) ABSTRACT

A merge mode for video coding is described that has motion vector difference based subblock-based temporal motion vector prediction. A base motion vector is selected for a current block. The current block is partitioned into sub-blocks. The sub-blocks are then decoded. For each sub-block of at least some of the sub-blocks, a motion shift that includes a direction and a distance is identified, the motion shift is applied to the base motion vector to obtain a refined motion vector, and each sub-block is decoded using the refined motion vector.

### CROSS REFERENCES TO RELATED APPLICATION

This application claims priority to and the benefit of U.S. Provisional Patent Application Ser. No. 63/438,782, filed Jan. 12, 2023, the entire disclosure of which is incorporated herein by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data and more particularly relates to motion vector coding candidate signaling.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include selecting a base motion vector for the current block. The method may also include partitioning the current block into sub-blocks. The method may include decoding the sub-blocks, where decoding the sub-blocks may include, for each sub-block of at least some of the sub-blocks: identifying a motion shift that includes a direction and a distance; applying the motion shift to the base motion vector to obtain a refined motion vector; and decoding the each sub-block using the refined motion vector. Other embodiments of this aspect include corresponding computer systems, apparatus, and computer programs recorded on one or more computer storage devices, each configured to perform the actions of the methods.

Implementations may include one or more of the following features. The method where selecting the base motion vector for the current block may include: decoding, from a compressed bitstream, an indication of the base motion vector; and selecting the base motion vector from a list of candidate motion vectors based on the indication.

The method may include: decoding, from a compressed bitstream, at least one syntax element that indicates that the current block is decoded based on partitioning the current block into the sub-blocks and motion shifts that include directions and distances.

The method where the at least one syntax element may include a first syntax element indicating that the current block is decoded based on partitioning the current block into the sub-blocks and a second syntax element indicating that at least some of the sub-blocks are decoded using the directions and the distances.

The method may include: decoding, from a compressed bitstream, a bitstring indicating which of the sub-blocks are encoded using motion shifts.

The method may include: decoding, from a compressed bitstream, a table of directions and distances. Identifying the motion shift that includes the direction and the distance may include: decoding, from the compressed bitstream, an index into the table; and using the index to obtain the direction and the distance from the table.

The base motion vector may be selected from a list of candidate motion vectors and the method may include: constructing the list of candidate motion vectors, where constructing the list of candidate motion vectors may include: identifying a new candidate motion vector to add to the list of candidate motion vectors; and adding the new candidate motion vector to the list of candidate motion vectors in response to determining that the list of candidate motion vectors does not include a motion vector that points to a same grid cell as the new candidate motion vector.

The base motion vector may be selected from a list of candidate motion vectors and the method may include: comparing a new candidate motion vector to other candidate motion vectors in the list of candidate motion vectors; and excluding the new candidate motion vector from the list of candidate motion vectors in a case that a motion shift associated with the new candidate motion vector is similar to a motion shift of another motion vector in the list candidate motion vectors.

Implementations of the described techniques may include hardware, a method or process, or a computer tangible medium.

In one general aspect, a method may include partitioning the current block into sub-blocks. The method may also include identifying a first neighboring block and a second neighboring block of the current block. The method may, include for each sub-block of at least some of the sub-blocks, obtaining a respective prediction block for the each sub-block by: obtaining, based on the first neighboring block, a first motion vector using a subblock-based temporal motion vector prediction mode; obtaining, based on the second neighboring block, a second motion vector using the subblock-based temporal motion vector prediction mode; and obtaining the respective prediction block for the sub-block based on the first motion vector and the second motion vector.

Implementations may include one or more of the following features. The method where the first neighboring block and the second neighboring block are selected from a predefined list of spatially neighboring available blocks.

The method where the first neighboring block is a bottom-left neighboring block of the current block, and where the second neighboring block is a top-right neighbor of the current block.

The method where identifying the first neighboring block and the second neighboring block of the current block may include: decoding, from a compressed bitstream, an indication of at least one of the first neighboring block or the second neighboring block.

The method where obtaining the respective prediction block for the each sub-block based on the first motion vector and the second motion vector may include: obtaining a motion vector that is a weighted combination of the first motion vector and the second motion vector; and obtaining the respective prediction block using the motion vector.

The method where a weighting of the first motion vector and the second motion vector is based on respective distances of the each sub-block to the first neighboring block and to the second neighboring block.

The method where obtaining the respective prediction block for the each sub-block based on the first motion vector and the second motion vector may include: obtaining a first prediction block based on the first motion vector; obtaining a second prediction block based on the second motion vector; and obtaining the respective prediction block as a weighted combination of the first prediction block and the second prediction block.

The method where a weighting of the first prediction block and the second prediction block is based on respective distances of the each sub-block to the first neighboring block and to the second neighboring block.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. For example, a non-transitory computer-readable storage medium may include executable instructions that, when executed by a processor, facilitate performance of operations operable to cause the processor to carry out any of the methods described herein. Aspects can be combined such that features described in the context of one aspect may be implemented in another aspect.

These and other aspects of the present disclosure are disclosed in the following detailed description of the embodiments and/or examples, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 is a diagram of motion vectors representing full and sub-pixel motion.

FIG. 7A illustrates an example of generating a group of motion vector candidates for a current block based on spatial neighbors of the current block.

FIG. 7B illustrates an example of generating a group of motion vector candidates for a current block based on temporal neighbors of the current block.

FIG. 7C illustrates an example of generating a group of motion vector candidates for a current block based on non-adjacent spatial candidates of the current block.

FIG. 8 illustrates the Subblock-based Temporal Motion Vector Prediction (SbTMVP) merge mode.

FIG. 9 illustrates combining sub-block motion vectors from multiple neighboring blocks.

FIG. 10 is an example of a flowchart of a technique for coding a current block.

FIG. 11 is an example of a flowchart of a technique for decoding a current block.

### DETAILED DESCRIPTION

As mentioned, compression schemes related to coding video streams may include breaking images into blocks and generating a digital video output bitstream (i.e., an encoded bitstream) using one or more techniques to limit the information included in the output bitstream. A received bitstream can be decoded to re-create the blocks and the source images from the limited information. Encoding a video stream, or a portion thereof, such as a frame or a block, can include using temporal similarities in the video stream to improve coding efficiency. For example, a current block of a video stream may be encoded based on identifying a difference (residual) between the previously coded pixel values, or between a combination of previously coded pixel values, and those in the current block.

Encoding using temporal similarities is known as inter prediction or motion-compensated prediction (MCP). A prediction block of a current block (i.e., a block being coded) is generated by finding a corresponding block in a reference frame following a motion vector (MV). That is, inter prediction attempts to predict the pixel values of a block using a possibly displaced block or blocks from a temporally nearby frame (i.e., a reference frame) or frames. A temporally nearby frame is a frame that appears earlier or later in time in the video stream than the frame (i.e., the current frame) of the block being encoded (i.e., the current block). A motion vector used to generate a prediction block refers to (e.g., points to or is used in conjunction with) a frame (i.e., a reference frame) other than the current frame. A motion vector may be defined to represent a block or pixel offset between the reference frame and the corresponding block or pixels of the current frame.

The motion vector(s) for a current block in MCP may be encoded into, and decoded from, a compressed bitstream. A motion vector for a current block is described with respect to a co-located block in a reference frame. The motion vector describes an offset (i.e., a displacement) in the horizontal direction (i.e., MVₓ) and a displacement in the vertical direction (i.e., MV_{y}) from the co-located block in the reference frame. As such, an MV can be characterized as a 3-tuple (f, MVₓ, MV_{y}) where f is indicative of (e.g., is an index of) a reference frame, MVₓ is the offset in the horizontal direction from a collocated position of the reference frame, and MV_{y} is the offset in the vertical direction from the collocated position of the reference frame. As such, at least the offsets MVₓ and MV_{y} are written (i.e., encoded) into the compressed bitstream and read (i.e., decoded) from the encoded bitstream. Several coding modes can be used to lower the rate cost of encoding motion vectors.

For example, the SKIP and MERGE modes are two coding modes that use lists of candidate MVs (or, equivalently, motion vectors from other blocks) to reduce the rate of encoding MVs. The SKIP and MERGE modes may have different semantics in different codecs. In an example of the SKIP mode, no residual information is transmitted from an encoder to a decoder. The decoder estimates an MV for a current block encoded using the SKIP mode from a list of candidate MVs and uses (e.g., selects) the MV to calculate a motion-compensated prediction for the current block. In an example of the MERGE mode, an MV from the list of candidate MVs is inherited for coding the current block. The list of candidate MVs may also be referred to as a merge list where the merge list may refer to blocks whose MVs (or, more generally, motion information) are used to select an MV (or, more generally, motion information) for a current block.

As another example, the reference motion vector (REFMV) and the new motion vector (NEWMV) inter prediction modes of the Alliance for Open Media (AOM) Video 1 (AV1) codec can also be used to lower the rate cost of encoding motion vectors. The REFMV inter-prediction mode indicates that the MV of a current block is a reference MV obtained from a list of candidate MVs. The NEWMV inter prediction mode can be used when the MV for a current block is not a zero MV, and is not any of the candidate MVs. In the NEWMV mode, the MV of the current block may be coded differentially using a reference MV from the list of candidate motion vectors.

As such, and at least as illustrated with respect to some of the coding modes described above, there is generally a need to construct a list of candidate MVs and to code an index of a reference MV (i.e., a selected MV) of the list of candidate MVs. That is, at the encoder, the list of candidate MVs may be constructed according to predetermined rules and the index of a selected MV candidate may be encoded in a compressed bitstream; and, at the decoder, the list of candidate MVs may be constructed (e.g., generated) according to the same predetermined rules and the index of the selected MV candidate may be either inferred or decoded from the compressed bitstream.

The predetermined rules for generating (e.g., deriving, or constructing and ordering) the list of candidate MVs and the number of candidates in the list may vary by codec. For example, in High Efficiency Video Coding (H.265), the list of candidate MVs can include up to 5 candidate MVs.

Codecs may populate the list of candidate MVs using different algorithms, techniques, or tools (collectively, tools). Each of the tools may produce a group of MVs that are added to the list of candidate MVs. For example, in Versatile Video Coding (H.266), the list of candidate MVs may be constructed using several modes, including intra-block copy (IBC) merge, block level merge, and sub-block level merge. The details of these modes are not necessary for the understanding of this disclosure. H.266 limits the number of candidate MVs obtained using IBC merge, block-level merge, and sub-block level merge, to 6 candidates, 6 candidates, and 5 candidates, respectively.

Described herein are different prediction modes that use lists of candidate MVs. Some such modes are the motion vector differences merge mode (MMVD), the Subblock-based Temporal Motion Vector Prediction merge mode (SbTMVP), and the sub-block MMVD merge mode that incorporates at least some aspects of MMVD into SbTMVP. The details of the MMVD, SbTMVP, and sub-block MMVD are described below. As becomes clear from the description below, problems exist with the sub-block MMVD mode. Specifically, using only one base motion shift for all sub-blocks of current block does not provide sufficient flexibility. Additionally, there may be redundant SbTMVP candidates, which is not efficient.

Implementations according to this disclosure solve problems such as these. A current block can be coded by partitioning the current block into sub-blocks. A first neighboring block and a second neighboring block of the current block are identified. For each sub-block for at least some of the sub-blocks, a respective prediction block is obtained. Obtaining the respective prediction block for the each sub-block can include obtaining, based on the first neighboring block, a first motion vector using a subblock-based temporal motion vector prediction mode; and obtaining, based on the second neighboring block, a second motion vector using the subblock-based temporal motion vector prediction mode. The respective prediction block for the sub-block can then be obtained based on the first motion vector and the second motion vector.

Further details of merge mode with motion vector difference based subblock-based temporal motion vector prediction are described herein with initial reference to a system in which it can be implemented.

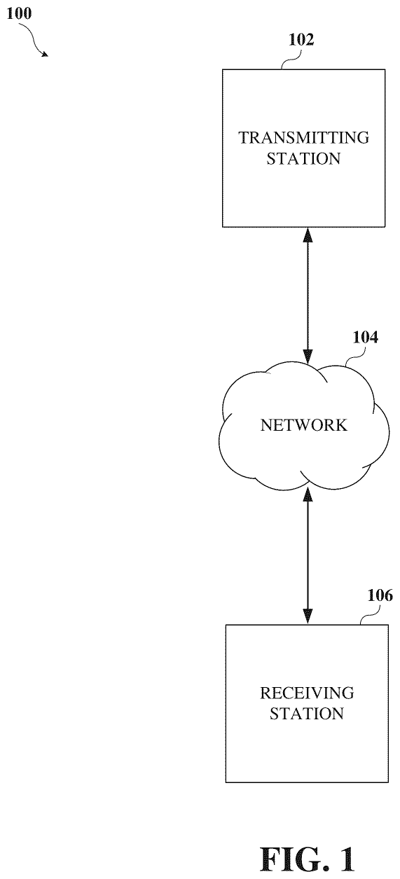

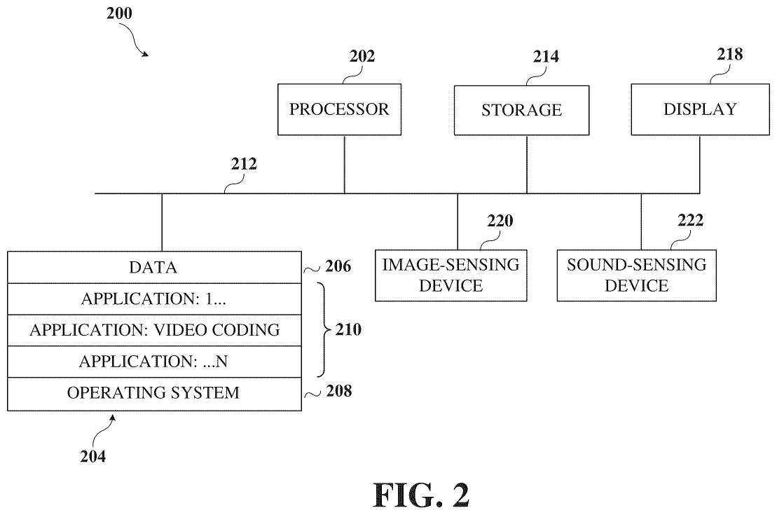

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

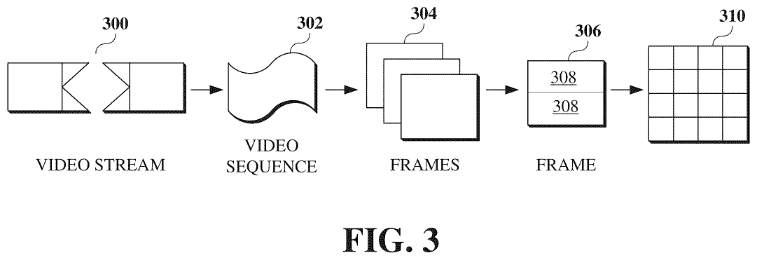

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

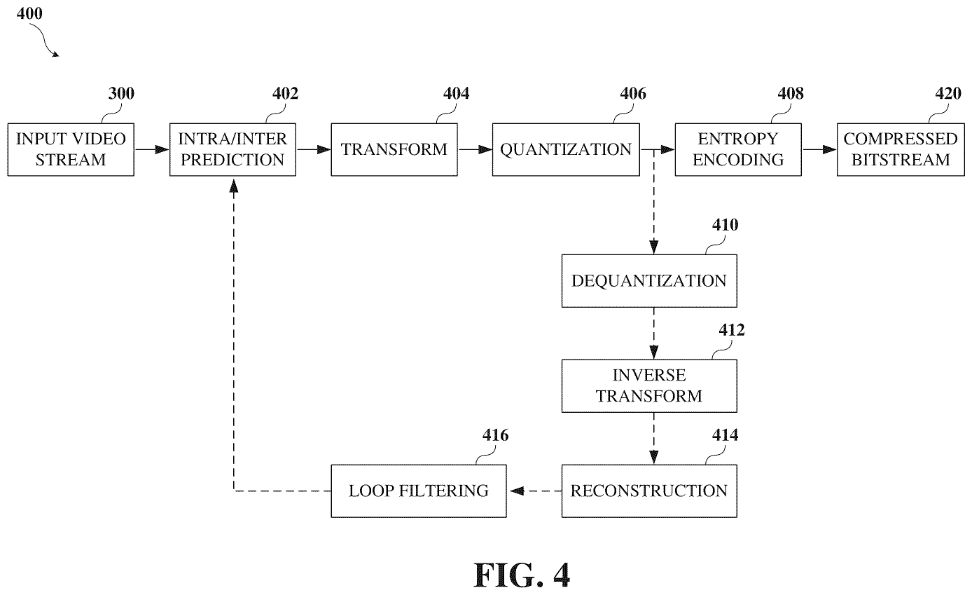

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

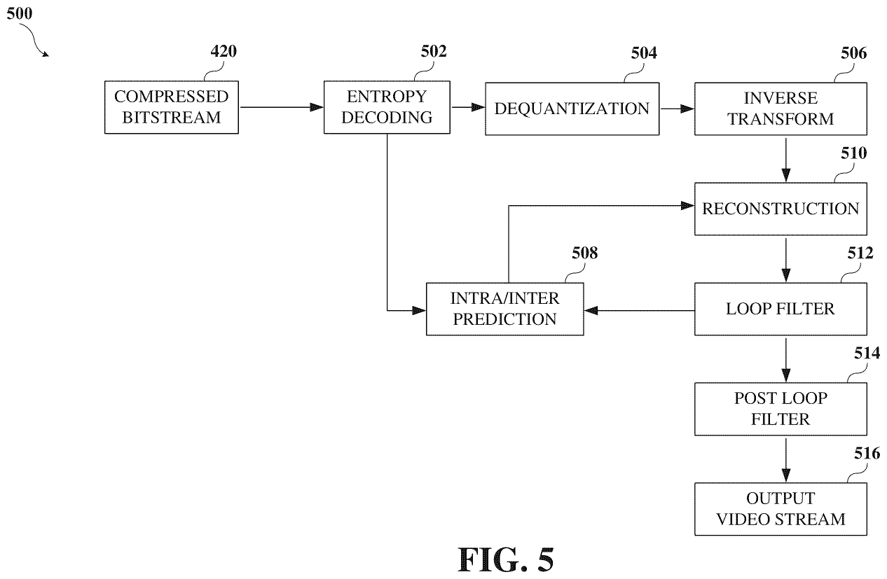

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post-loop filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post-loop filtering stage 514 (e.g., without applying any filters in the post-loop filtering stage 514).

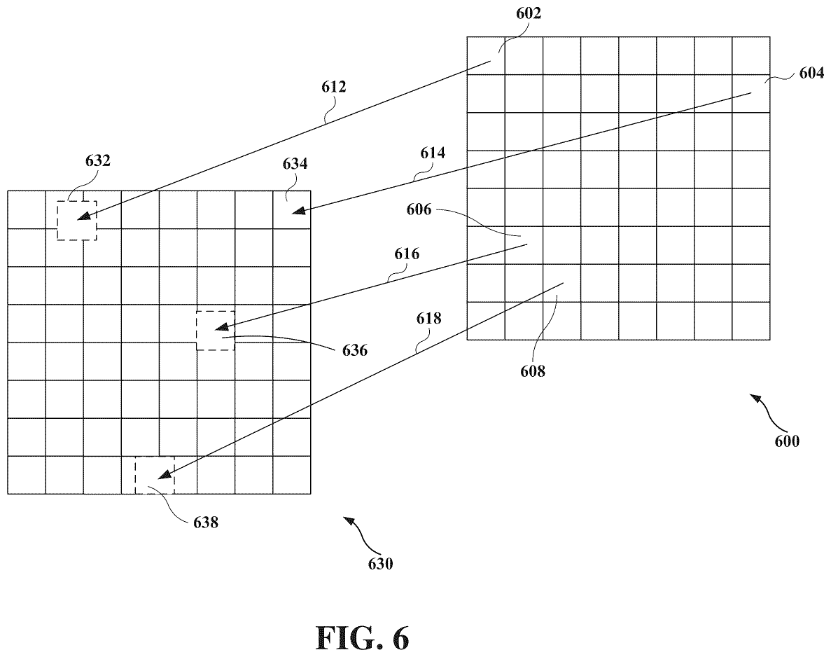

FIG. 6 is a diagram of motion vectors representing full and sub-pixel motion. In FIG. 6, several blocks 602, 604, 606, 608 of a current frame 600 are inter predicted using pixels from a reference frame 630. In this example, the reference frame 630 is a reference frame, also called the temporally adjacent frame, in a video sequence including the current frame 600, such as the video stream 300. The reference frame 630 is a reconstructed frame (i.e., one that has been encoded and decoded such as by the reconstruction path of FIG. 4) that has been stored in a so-called last reference frame buffer and is available for coding blocks of the current frame 600. Other (e.g., reconstructed) frames, or portions of such frames may also be available for inter prediction. Other available reference frames may include a golden frame, which is another frame of the video sequence that may be selected (e.g., periodically) according to any number of techniques, and a constructed reference frame, which is a frame that is constructed from one or more other frames of the video sequence but is not shown as part of the decoded output, such as the output video stream 516 of FIG. 5.

A prediction block 632 for encoding the block 602 corresponds to a motion vector 612. A prediction block 634 for encoding the block 604 corresponds to a motion vector 614. A prediction block 636 for encoding the block 606 corresponds to a motion vector 616. Finally, a prediction block 638 for encoding the block 608 corresponds to a motion vector 618. Each of the blocks 602, 604, 606, 608 is inter predicted using a single motion vector and hence a single reference frame in this example, but the teachings herein also apply to inter prediction using more than one motion vector (such as bi-prediction and/or compound prediction using two different reference frames), where pixels from each prediction are combined in some manner to form a prediction block.

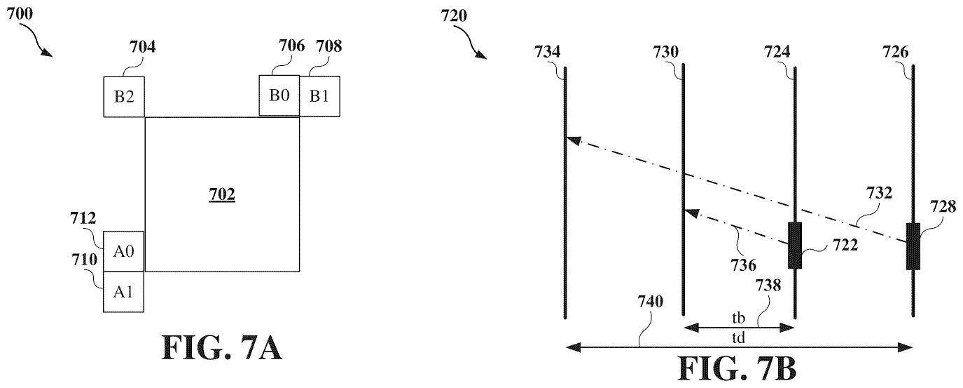

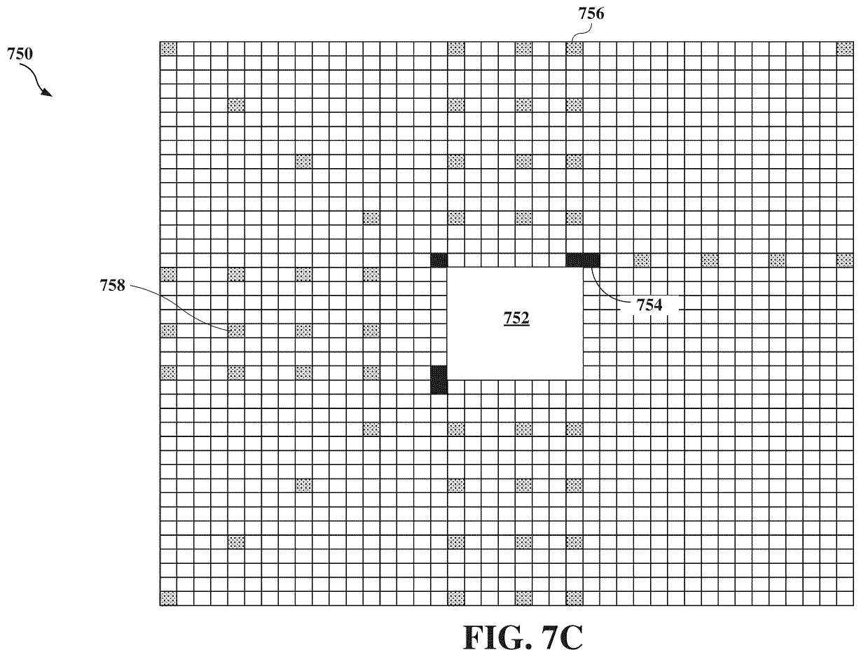

FIGS. 7A-7C illustrate examples of tools for generating groups of motion vectors. As mentioned above, a list of candidate MVs may be obtained using different tools. An encoder, such as the encoder 400 of FIG. 4, and a decoder, such as the decoder 500 of FIG. 5, may use the same tools for obtaining (e.g., populating, constructing, etc.) the same list of candidate MVs. The candidate MVs obtained using a tool are referred to herein as a group of candidate MVs. At least some of the tools described herein may be known or may be similar to or used by other codecs. However, the disclosure is not limited to or by any particular tools that can generate groups of MV candidates.

As mentioned above, merge candidates or candidate MVs may be derived using different tools. Some such tools are now described.

FIG. 7A illustrates an example 700 of generating a group of motion vector candidates for a current block based on spatial neighbors of the current block. The example 700 may be referred to or may be known as generating or deriving spatial merge candidates. The spatial merge mode is limited to merging with spatially-located blocks in the same picture.

A current block 702 may be “merged” with one of its spatially available neighboring block(s) to form a “region.” FIG. 7A illustrates that spatially available neighboring blocks includes blocks 704-712 (i.e., blocks 704, 706, 708, 710, 712). As such, up to six MV candidates (i.e., corresponding to the MVs of the blocks 704-712) may be possible (i.e., added to the list of candidate motion vectors or the merge list). However, more or fewer spatially neighboring blocks may be considered. In an example, a maximum of four merge candidates may be selected from amongst candidate blocks 704-712.

All pixels within the merged region share the same motion parameters (e.g., the same MV(s) and reference frame(s)). Thus, there is no need to code and transmit motion parameters for each individual block of the region. Instead, for a region, only one set of motion parameters is encoded and transmitted from the encoder and received and decoded at the decoder. In an example, a flag (e.g., “merge_flag”) may be used to specify whether the current block is merged with an available neighboring block. Additionally, an index of the MV candidate in the list of MV candidates of the neighboring block with which the current block is merged.

FIG. 7B illustrates an example 720 of generating a group of motion vector candidates for a current block based on temporal neighbors of the current block. The example 720 may be referred to or may be known as generating or deriving temporal merge candidates or as a temporal merge mode. In an example, the temporal merge mode may be limited to merging with temporally co-located blocks in neighboring frames. In another example, blocks in other frames other than a co-located block may also be used.

A co-located block may be a block that is in a similar position as the current block in another frame. Any number of co-located blocks can be used. That is, the respective co-located blocks in any number of previously coded pictures can be used. In an example, the respective co-located blocks in all of the previously coded frames of the same group of pictures (GOP) as the frame of the current block are used. Motion parameters of the current block may be derived from temporally-located blocks and used in the temporal merge.

The example 720 illustrates that a current block 722 of a current frame 724 is being coded. A frame 726 is a previously coded frame, a block 728 is a co-located block in the frame 726 to the current block 722, and a frame 730 is a reference frame for the current frame. A motion vector 732 is a the motion vector of the block 728. The frame 726, which includes the co-located block 728, may be referred to as the “collocated picture” or collocated frame.” The motion vector 732 points to a reference frame 734. The reference frame 734, which is the reference frame of the collocated picture, may be referred to as the “collocated reference picture” or the “collocated reference frame.” As such, a motion vector 736, which may be a scaled version of the motion vector 732 can be used as a candidate MV for the current block 722. The motion vector 732 can be scaled by a distance 738 (denoted tb) and a distance 740 (denoted td). The distance can be the picture order count (POC) or the display order of the frames. As such, in an example, tb can be defined as the POC difference between the reference frame (i.e., the frame 730) of the current frame (i.e., the current frame 724) and the current frame; and td is defined to be the POC difference between the reference frame (i.e., the reference frame 734) of the co-located frame (i.e., the frame 726) and the co-located frame (i.e., the frame 726).

FIG. 7C illustrates an example 750 of generating a group of motion vector candidates for a current block 752 based on non-adjacent spatial candidates of the current block. A current block 752 illustrates a largest coding unit (which may be further divided into sub-blocks), which may be divided into sub-blocks and where at least some of the sub-blocks may be inter predicted. Blocks that are filled with the black color, such as a block 754, illustrate the neighboring blocks described with respect to FIG. 7A. Blocks filled with the dotted pattern, such as blocks 756, 758 are used for obtaining the group of motion vector candidates for the current block 752 based on non-adjacent spatial candidates.

An order of evaluation of the non-adjacent blocks may be predefined. However, for brevity, the order is not illustrated in FIG. 7C and is not described herein. The group of candidate MVs based on non-adjacent spatial candidates may include 5, 10, fewer, or more MV candidates.

Another example (not illustrated) of generating a group of MV candidates (or merge candidates) for a current block can be history based MV derivation, which may be referred to as history based MV prediction (HMVP) mode.

In the HMVP mode, the motion information of a previously coded block can be stored in a table and used as a candidate MV for a current block. The table with multiple HMVP candidates can be maintained during the encoding/decoding process. The table can be reset (emptied) when a new row of largest coding units (which may be referred to as a superblock or a macroblock) is encountered.

In an example, The HMVP table size may be set to 6, which indicates that up to 6 HMVP candidate MVs may be added to the table. When inserting a new candidate MV into the table, a constrained first-in-first-out (FIFO) rule may be utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table can be checked in order and inserted to the candidate MV list after the temporal merge candidate. A codec may apply redundancy check on the HMVP candidates to the spatial or temporal merge candidate(s).

Yet another example (not illustrated) of generating a group of candidate MVs for a current block can be based on averaging predefined pairs of MV candidates in the already generated groups of MV candidates of the list of MV candidates.

Pairwise average MV candidates can be generated by averaging predefined pairs of candidates in the existing merge candidate list, using motion vectors of already generated groups of MVs. The first merge candidate is defined as pOCand and the second merge candidate can be defined as p1Cand, respectively. The averaged motion vectors are calculated according to the availability of the motion vector of p0Cand and p1Cand separately for each reference list. If both motion vectors are available in one list, these two motion vectors can be averaged even when they point to different reference frames, and the reference frame for the average MV can be set to be the same reference frame as that of pOCand; if only one MV is available, use the one directly; if no motion vector is available, keep this list invalid. Also, if the half-pel interpolation filter indices of p0Cand and p1Cand are different, the half-pel interpolation filter is set to 0.

In yet another example (not illustrated), a group of zero MVs may be generated. A current reference frame of a current block may use one of N reference frames. A zero MV is a motion vector with displacement (0, 0). The group of zero MVs may include 0 or more zero MVs with respect to at least some of the N reference frames.

It is again noted that the tools described herein for generating groups of candidate MVs do not limit the disclosure in any way and that different codecs may implement such tools differently or may include fewer or more tools for generating candidate MVs or merge candidates.

To summarize, a conventional codec may generate a list of candidate MVs using different tools. Each tool may be used to generate a respective group of candidate MVs. Each group of candidate MVs may include one or more candidate MVs. The candidate MVs of the groups may be appended to the list of candidate MVs in a predefined order. The list of candidate MVs has a finite size and the different tools are used until the list is full. For example, the list of candidate MVs may be of size 6, 10, 15, or some other size. For example, spatial merge candidates may be first be added to the list of candidate MVs. If the list is not full, then at least some of temporal merge candidates may be added. If the list is still not full, then at least some of the HMVP candidates may be added. If the list is still not full, then at least some of the pairwise average MV candidates may be added. If the list is still not full, then zero MVs may be added. The size of the list of candidate MVs may be signaled in the compressed bitstream and the maximum allowed size of the merge list may be pre-defined. For each coding unit, an index of the best merge candidate may be encoded using truncated unary binarization. In an example, the first bin of the merge index may be coded with context and bypass coding may be used for other bins.

Additionally, conventional codecs may perform redundancy checks so that the same motion vector is not added more than once at least in the same group of candidate MVs. To illustrate, after the candidate at position A1 of FIG. 7A (i.e., the block 710) is added, the addition of the remaining candidates may be subject to a redundancy check to ensure that candidates with the same motion information are excluded from the list. As another illustration, redundancy checks may be applied on the HMVP candidates with the spatial or temporal merge candidates. In some codecs, and to reduce the number of redundancy check operations, simplifications may be introduced, such as, once the total number of available merge candidates reaches the maximally allowed merge candidates minus 1, the merge candidate list construction process from HMVP is terminated.

In addition to the MERGE mode described above, MMVD merge mode may also be supported. In MMVD, after a merge candidate is selected, the merge candidate is further refined by signaled MVD information. A flag (i.e., an MMVD flag) may be signaled following a merge flag to specify whether the MMVD mode is used for a coding unit, such as the current block 702 of FIG. 7A, the current block 722 of FIG. 7B, or the current block 722 of FIG. 7C. For example, if the MMVD flag is set to 1 (i.e., true), then the MMVD mode is applied to the coding unit. In MMVD mode, one of the first two candidates in the merge list is selected to be used as the MV basis (which may also be referred to as a “starting MV,” “base MV,” or “base candidate”). An MMVD candidate flag is signaled to specify which one is used between the first and second merge candidates.

In the MMVD mode, a distance and a direction are further signaled if the MMVD flag is true. A distance index (Distance IDX) specifies motion magnitude information and indicates the pre-defined offset from the MV basis. An offset can be added to either the horizontal component or the vertical component of the MV basis (e.g., the base merge candidate). The offsets may be different for a L0 motion vector and a L1 motion vector of the same block. The relation of distance index and pre-defined offset is specified in Table 1. The relation between the distance index and the pre-defined offset can be as specified in Table I.

TABLE I

| | Distance IDX | | | | | | | |
|---|---|---|---|---|---|---|---|---|
| | 0 | 1 | 2 | 3 | 4 | 5 | 6 | 7 |
| Offset (in units | ¼ | ½ | 1 | 2 | 4 | 8 | 16 | 32 |
| of luma sample) | | | | | | | | |

A direction index (Direction IDX) represents the direction of the motion vector difference (MVD) relative to the starting point (i.e., the MV basis). The direction index can be one of the four directions as shown in Table II.

TABLE II

Direction IDX

| | 00 | 01 | 10 | 11 |
|---|---|---|---|---|
| x-axis | + | − | N/A | N/A |
| y-axis | N/A | N/A | + | − |

The MVD can be scaled according to the difference of POCs in each direction. The MVD can be scaled as described above with respect to the scaling of motion vectors.

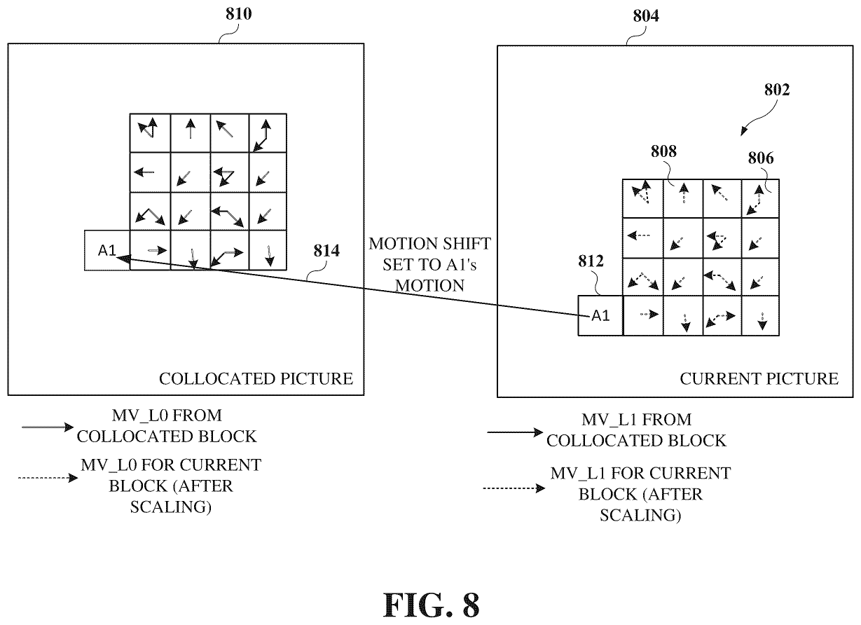

SbTMVP is another special merge mode that may be supported. FIG. 8 illustrates the SbTMVP merge mode. SbTMVP uses a motion field in a collocated frame to improve motion vector prediction and merge mode for a current block in a current frame. In the SbTMVP mode, motion can be predicted at sub-block level. For example, a current block 802 of a current frame 804 may be partitioned into sub-blocks, such as sub-blocks 806 and 808. The sub-blocks may be of size 8×8. However, other sizes are possible. In the SbTMVP merge mode, motion (e.g., motion parameters) can be predicted for each of the sub-blocks of the current block 802.

The SbTMVP merge mode can also apply a motion shift before obtaining (e.g., fetching, accessing, calculating, selecting, etc.) the temporal motion information from a collocated frame 810. The motion shift can be obtained from the motion vector from one of the spatial neighboring blocks of the current block 802. The spatial neighbors, such as at least a subset of those shown in FIG. 7A may be examined in a certain order to identify a first spatial neighboring block that has a motion vector using the collocated picture as its reference picture. Then, the motion vector using the collected picture as its reference picture is selected to be the motion shift to be applied. For illustration purposes, assume that the neighboring block 812 has a motion vector that uses the collocated frame 810 as its reference frame. Thus, this motion vector can be selected to be the motion shift to be applied. If none of the neighboring blocks has a motion vector that uses the collocated frame 810 as its reference frame, then the motion shift is set to (0, 0).

In a second step (i.e., after selecting the motion shift), the identified motion shift can be applied (i.e. such as by adding the motion shift to the coordinates of the current block 802) to obtain sub-block level motion information (i.e., motion vectors and reference indices) from the collocated frame 810. FIG. 8 illustrates that the motion shift (i.e., a motion shift 814) is set to the motion information of the neighboring block 812. Subsequently, for each sub-block of the current block 802, the motion information of its corresponding block (the smallest motion grid that covers the center sample) in the collocated frame 810 can be used to derive the motion information for the sub-block. After the motion information of the collocated sub-block is identified, it is converted to the motion vectors and reference indices of the current sub-block using temporal scaling to align the reference pictures of the temporal motion vectors to those of the current block.

Another merge mode may combine MMVD and SbTMVP. Such mode may be referred to as sub-block MMVD merge mode. In the sub-block MMVD merge mode, an MMVD index is additionally signaled for the SbTMVP merge candidate to indicate an additional offset of the motion shift of SbTMVP candidate. The MMVD index can include one or both of the distance index and direction index described above with respect to the MMVD mode. The additional motion shift (i.e., the MMVD index) is added to the motion shift of the SbTMVP as a final motion shift. The motion field that is pointed by the final motion shift is used as the sub-block MMVD candidate.

By using the different motion shift offsets, different subblock-based motion field data could be applied in the sub-block MMVD merge mode. The step sizes can be {4, 8, 12, 16, . . . }. The unit in the step size is the integer pixel unit. The direction in the sub-block MMVD merge mode can be 8. The total number of the available candidates in the sub-block MMVD merge mode is less than or equal to 16. Subblock-based template-matching can also be applied for all candidates of the sub-block MMVD merge mode to reorder the candidate list by using the template-matching (TM) cost in ascending order. Then, only the 16 candidates with the smallest TM costs will be signaled.

A merge mode (referred to herein as the MMVD-SbTMVP mode) that combines the MMVD and SbTMVP merge modes is disclosed. The MMVD and SbTMVP merge modes are combined in such a way that the motion shift used for the SbTMVP mode is derived based on the MMVD. That is, instead of obtaining one motion shift (from one of the spatially neighboring blocks) for all of the sub-blocks of a coding unit, as described above with respect to SbTMVP, in the MMVD-SbTMVP mode, each of the sub-blocks can have its own motion shift, which may be specified as described above with respect to the MMVD mode. In the MMVD-SbTMVP mode, the same merge candidate is used for all of the sub-blocks, similar to the SbTMVP mode.

In an example, an encoder, such as the encoder 400 of FIG. 4, may encode in, and a decoder, such as the decoder 500 of FIG. 5, may decode from a compressed bitstream motion shift information for a coding unit. The motion shift information can be encoded in a header associated with the coding unit. The encoder may determine, such as based on a rate-distortion analysis, which sub-blocks of the coding unit are to be decoded using motion vector refinement based on MMVD and what MMVD data are for the different sub-blocks.

In an example, the motion shift information can include a bitstring. The bitstring can include, for each sub-block, one bit that indicates whether the compressed bitstream includes MMVD data for the sub-block where the MMVD data associated with the block is used to refine the merge candidate (or base MV). The bitstring may be encoded in any number of ways, such as using run-length encoding or some other bitstring coding technique. The MMVD data for a sub-block can include a distance and a direction, which can be as described above.

In an example, the compressed bitstream can include (such as in the CU header) a table (e.g., a set) of MMVD data (e.g., a set of distances and directions). As such, instead of separately coding MMVD data for subblocks, for a sub-block that is coded using the MMVD-SbTMVP mode, the compressed bitstream can include an index into the table. As such, when decoding a sub-block, the index associated with the sub-block can then be used to look up (e.g., retrieve) the MMVD data from the table. As already mentioned, the MMVD data can be used to refine the base MV for decoding the sub-block.

In an example, more than one collocated frame may be signaled (e.g., encoded) in a compressed bitstream. In an example, the more than one collocated frame may be signaled in a sequence parameter set (SPS), a picture parameter set (PPS), a header of a group of pictures (GOP), a frame header, a slice header, or some other grouping of blocks or frames that can be configured to share (e.g., reuse) common coding information. When more than one collocated frame is signaled, the signaling order indicates the priority of the collocated frames. That is, the first signaled collocated frame is first checked and will be used when available.

In an example, whether a coding unit is coded using the MMVD-SbTMVP merge mode may be indicated using more than one syntax element. For example, a first syntax element can indicate that the coding block is coded using the SbTMVP mode and second syntax element can indicate whether the motion shift information is to obtained from a spatially neighboring block (as described above with respect to SbTMVP) or whether the motion shift information is MMVD.

Alternatively, the bitstream may include one syntax element indicating the MMVD-SbTMVP merge mode. That is, instead of coding separate syntax elements that collectively indicate that the MMVD-SbTMVP merge mode is to be applied, and such as described above with respect to the sub-block MMVD mode, one syntax element indicates that MMVD-SbTMVP merge mode is to be applied. As such, the MMVD-SbTMVP merge mode can be a new category of merge mode and can be at the same level as the regular merge mode or Sub-block merge and can be signaled in a similar way as Sub-block merge.

In one example, the maximum base merge candidate number for the MMVD-SbTMVP merge mode can be the same as that of the regular merge mode (i.e., the MERGE mode described above). The base merge candidates can be derived in the same way as the regular merge candidates. The MVD information can be further signaled on top of (i.e., in addition to) a base candidate, as described above with respect to MMVD signaling. Again, “base candidate” refers to the selected candidate from a list of candidate MVs and which is further refined.

In an example, a base candidate may be pruned based on a distance from the motion shift determined by this base candidate to motion shifts by the existing base candidates in the base candidate list. That is, when constructing the list of candidate MVs, when a new candidate MV is considered, the candidate MV is compared to the other candidate MVs already in the list of candidate MVs. If the motion shift of the new candidate (how much and in which direction it moves a part of the image) is considered similar (e.g., meets a similarity criterion) to the motion shift of an existing candidate in the list, then the new candidate MV is not added to list of candidate MVs. In one example, if the motion shift of the new base candidate is in the same sub-block grid (e.g., luma 4×4 grid or luma 8×8 grid) in the reference frame of the motion shift of an existing base candidate, the new base candidate can be pruned and may not be added to the base candidate list. In an example, the sub-block size may be predefined. In another example, the sub-block size may be signaled in the compressed bitstream.

Stated another way, unnecessary base candidates may be eliminated (e.g., not added to the list of candidate MVs). Essentially, any new candidate MV that is too similar to those already on the list is not added to the list. The similarity can be determined based on locations on a grid (e.g., a 4×4 or 8×8 grid). If a new candidate's motion shift (its movement direction and distance) is on the same grid cell as a candidate MV that is already on the list of candidate MVs, the new candidate is not added to the list of candidate MVs.

In an example, sub-block MVs from multiple neighboring blocks can be combined. When two or more candidate neighboring blocks are available, the candidate sub-block MVs can be combined for prediction in the current block. For each of the candidate neighboring blocks, sub-block motion vectors can be obtained as described above with respect to FIG. 8.

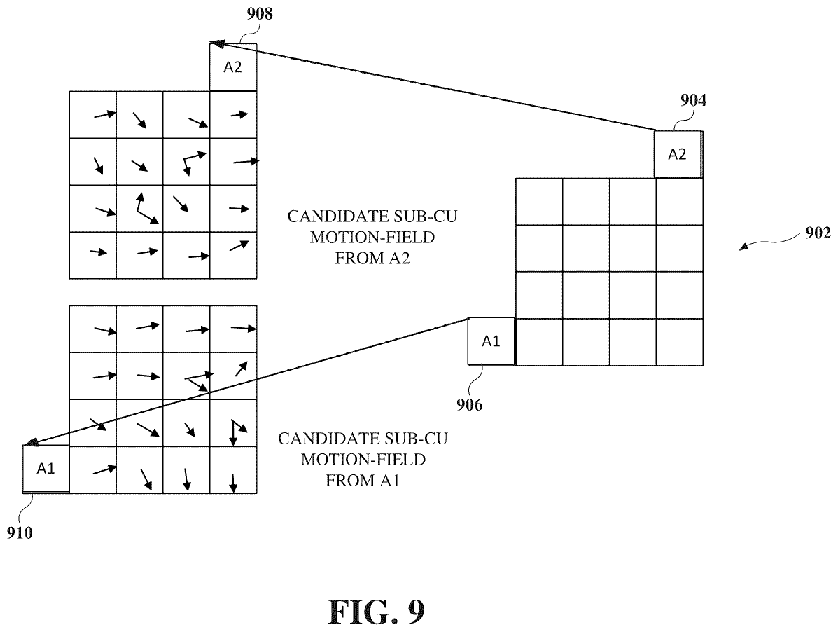

FIG. 9 illustrates combining sub-block MVs from multiple neighboring blocks. FIG. 9 illustrates that a top-right neighbor 904 and a bottom-left neighbor 906 of a current block 902 are available. Blocks 908 and 910 are the reference blocks, in respective collocated reference frames, corresponding to the top-right neighbor 904 and the bottom-left neighbor 906, respectively. The candidate sub-block MVs obtained, using the SbTMVP merge mode, for each of the top-right neighbor 904 and the bottom-left neighbor 906 may be combined for prediction of the sub-blocks of the current block 902.

In an example, the MVs of a sub-block of the current block 902 may be blended or weighted based on the distance of the sub-block from the base candidates (i.e., the candidates that are to be blended or combined). In an example, for each sub-block one of the available candidates may be selected (for obtaining the MVs of the sub-block) based on distance of the sub-block from the base candidates. In an example, signaling (from the encoder to the decoder) may be used to convey which sub-block MV set to select for each sub-block. In yet another example, the predictors obtained for each sub-block from the available MV sets may be blended using a distance based weighting mechanism.

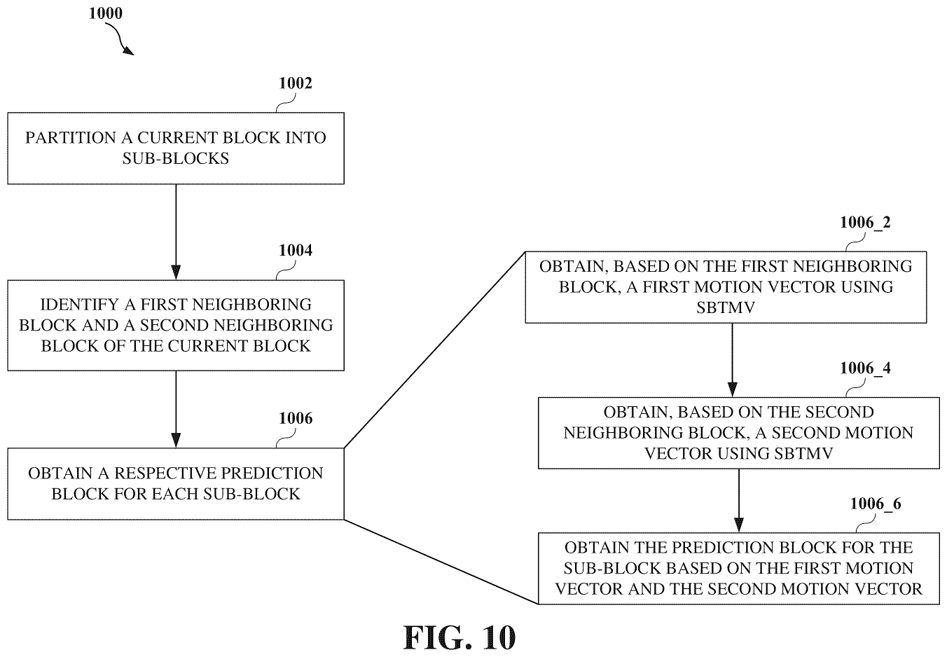

FIG. 10 is an example of a flowchart of a technique 1000 for coding a current block.

The technique 1000 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1000. The technique 1000 may be implemented in whole or in part in the intra/inter prediction stage 508 of the decoder 500 of FIG. 5 or the intra/inter prediction stage 402 of the encoder 400 of FIG. 4. As such, when implemented by a decoder, “coding” means “decoding;” and when implemented by an encoder, “coding” means “encoding.” The technique 1000 can be implemented using specialized hardware or firmware. Multiple processors, memories, or both, may be used.

At 1002, the current block is partitioned into sub-blocks. In an example, the current block can be partitioned into sub-blocks of size 8×8 or of size 4×4 luma sub-blocks.

At 1004, a first neighboring block and a second neighboring block of the current block are identified. In an example, the first neighboring block and the second neighboring block can be, respectively, a bottom-left neighboring block and a top-right neighbor. Other first and second neighboring blocks may be identified (e.g., selected, chosen, etc.). For example, the first and the second neighboring blocks can be selected from spatially available neighboring blocks, which can be any of blocks 704, 706, 708, 710, 712 of FIG. 7A. As such, the first neighboring block and the second neighboring block can be selected from a predefined list of spatially neighboring available blocks.

In an example, which of neighboring blocks are identified can be signaled in a compressed bitstream, such as the compressed bitstream 420 of FIG. 5. As such, when implemented in a decoder, identifying the first neighboring block and the second neighboring block can include decoding, from the compressed bitstream, an indication (e.g., an index) of at least one of the first neighboring block or the second neighboring block. When implemented in an encoder, the technique 1000 can include encoding, in the compressed bitstream, the indication of the at least one of the first neighboring block or the second neighboring block. In an example, one of the first neighboring block or the second neighboring block may be inferred and the other of the first neighboring block or the second neighboring block may be signaled. For example, the first available spatial neighboring block, in a scanning order, may be selected as the first neighboring block and the second neighboring block to be identified can be signaled.

At 1006, a respective prediction block is obtained for each sub-block. Obtaining a respective prediction block for a sub-block includes obtaining (at 1006_2), based on the first neighboring block, a first motion vector using a subblock-based temporal motion vector prediction mode; obtaining (at 1006_4), based on the second neighboring block, a first motion vector using the subblock-based temporal motion vector prediction mode; and obtaining (at 1006_6) the respective prediction block for the sub-block based on the first motion vector and the second motion vector.

In an example, obtaining the respective prediction block for the each sub-block based on the first motion vector and the second motion vector can include obtaining a motion vector that is a weighted combination of the first motion vector and the second motion vector. The respective prediction block can then be obtained using the motion vector. In an example, a weighting of the first motion vector and the second motion vector can be based on respective distances of the each sub-block to the first neighboring block and to the second neighboring block. The respective distances can be the Cartesian distances.

In an example, obtaining the respective prediction block for the each sub-block based on the first motion vector and the second motion vector can include obtaining a first prediction block based on the first motion vector and obtaining a second prediction block based on the second motion vector. The respective prediction block can then be obtained as a weighted combination of the first prediction block and the second prediction block. In an example, a weighting (i.e., a pair-wise weighting) of the first prediction block and the second prediction block can be based on respective distances of the each sub-block to the first neighboring block and to the second neighboring block.

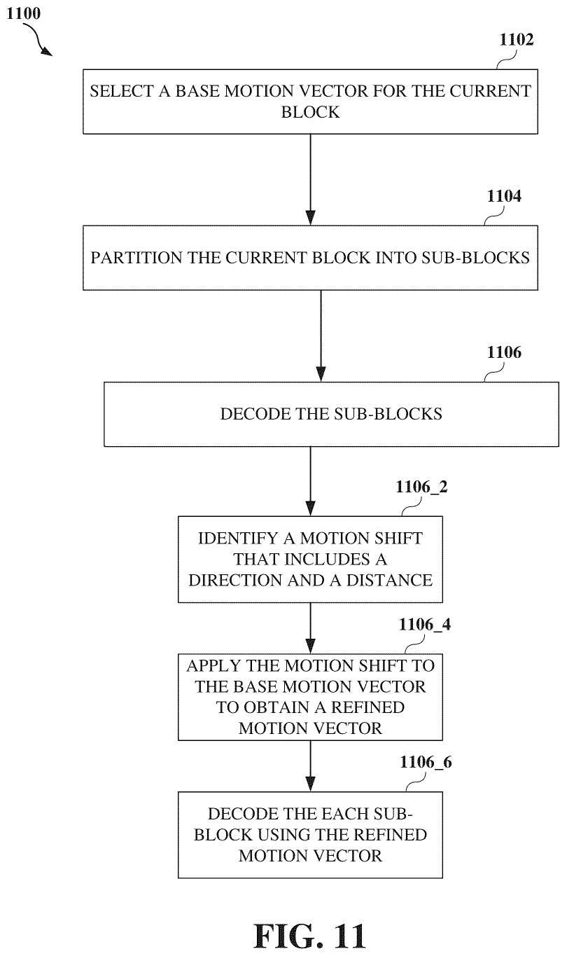

FIG. 11 is an example of a flowchart of a technique 1100 for coding a current block (e.g., a coding unit). The current block is decoded using the MMVD-SbTMVP merge mode. In an example, at least one syntax element that indicates that the current block is decoded using the MMVD-SbTMVP merge mode may be decoded from a compressed bitstream, such as the compressed bitstream 420 of FIG. 5. That is, the at least one syntax element indicates that the current block is to be decoded based on partitioning the current block into sub-blocks and motion shifts that include directions and distances. In an example, the at least one syntax element can be or include two syntax elements: a first syntax element that indicates that the current block is decoded based on partitioning the current block into the sub-blocks and a second syntax element that indicates that at least some of the sub-blocks are decoded using the directions and the distances.

The technique 1100 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 1100. The technique 1100 may be implemented in whole or in part in the intra/inter prediction stage 508 of the decoder 500 of FIG. 5 The technique 1100 can be implemented using specialized hardware or firmware. Multiple processors, memories, or both, may be used.

At 1102, a base motion vector for the current block is selected. The base motion vector can be selected from a list of candidate MVs. An index of the based motion vector into the list of candidate MVs may be decoded from the compressed bitstream. As such, an indication of the base motion vector may be decoded form the compressed bitstream and the base motion vector is selected from a list of candidate motion vectors based on the indication.

In an example, the technique 1100 may construct the list of candidate MVs. Constructing the list of candidate motion vectors can include identifying a new candidate motion vector to add to the list of candidate motion vectors. The new candidate motion vector can be added to the list of candidate motion vectors in response to determining that the list of candidate motion vectors does not include a motion vector that points to the same grid cell as the new candidate motion vector. Stated another way, the new candidate motion vector can be compared to other candidate motion vectors in the list of candidate motion vectors. In the case that a motion shift associated with the new candidate motion vector is similar to a motion shift of another motion vector that is already in the list candidate motion vectors, the new candidate motion vector is excluded from (e.g., is not added to) the list of candidate motion vectors.

At 1104, the current block is partitioned into sub-blocks. At 1106, the sub-blocks are decoded. At least some of the sub-blocks are decoded using respective motion shifts (e.g., directions and a distances). As described above, a bitstring indicating which of the sub-blocks are encoded using motion shifts may be decoded from the compressed bitstream. If a sub-block is not to be decoded using motion shifts, then the sub-block is decoded only using the base motion vector. For each of those sub-blocks that are to be decoded using motion shifts, the technique 1100 performs 1106_2 through 1106_6.

For a sub-block, at 1106_2, a motion shift that includes a direction and a distance is identified for the sub-block. In an example, the direction and the distance are decoded from the compressed bitstream. In another example, and as described above, the compressed bitstream can include a table of directions and distances. As such, the technique 1100 can decode the table of directions and distances from the compressed bitstream. Then, for a given sub-block, an index into the table is decoded from the compressed bitstream. The index is used to obtain (e.g., retrieve, access, select, etc.) the direction and the distance from the table.

At 1106_4, the motion shift is applied to the base motion vector to obtain a refined motion vector. At 1106_6, the sub-block is decoded using the refined motion vector. For example, the block in the reference frame where the refined motion vector points can be used as the sub-block itself.

For simplicity of explanation, the techniques described herein, such as the technique 1000 of FIG. 10 and the technique 1100 of FIG. 11, are each depicted and described as a respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a (e.g., non-transitory) computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

1. A method for decoding a current block, comprising:
selecting a base motion vector for the current block;
partitioning the current block into sub-blocks; and
decoding the sub-blocks, wherein decoding the sub-blocks comprises:
for each sub-block of at least some of the sub-blocks:
identifying a motion shift that includes a direction and a distance;
applying the motion shift to the base motion vector to obtain a refined motion vector; and
decoding the each sub-block using the refined motion vector.

2. The method of claim 1, where selecting the base motion vector for the current block comprises:
decoding, from a compressed bitstream, an indication of the base motion vector; and
selecting the base motion vector from a list of candidate motion vectors based on the indication.

3. The method of claim 1, further comprising:
decoding, from a compressed bitstream, at least one syntax element that indicates that the current block is decoded based on partitioning the current block into the sub-blocks and motion shifts that include directions and distances.

4. The method of claim 3, wherein the at least one syntax element comprises a first syntax element indicating that the current block is decoded based on partitioning the current block into the sub-blocks and a second syntax element indicating that at least some of the sub-blocks are decoded using the directions and the distances.

5. The method of claim 1, further comprising:
decoding, from a compressed bitstream, a bitstring indicating which of the sub-blocks are encoded using motion shifts.

6. The method of claim 1, further comprising:
decoding, from a compressed bitstream, a table of directions and distances.

7. The method of claim 6, wherein identifying the motion shift that includes the direction and the distance comprises:
decoding, from the compressed bitstream, an index into the table; and
using the index to obtain the direction and the distance from the table.

8. The method of claim 1, wherein the base motion vector is selected from a list of candidate motion vectors, the method further comprising:
constructing the list of candidate motion vectors, wherein constructing the list of candidate motion vectors comprises:
identifying a new candidate motion vector to add to the list of candidate motion vectors; and
adding the new candidate motion vector to the list of candidate motion vectors in response to determining that the list of candidate motion vectors does not include a motion vector that points to a same grid cell as the new candidate motion vector.

9. The method of claim 1, wherein the base motion vector is selected from a list of candidate motion vectors, the method further comprising:
comparing a new candidate motion vector to other candidate motion vectors in the list of candidate motion vectors; and
excluding the new candidate motion vector from the list of candidate motion vectors in a case that a motion shift associated with the new candidate motion vector is similar to a motion shift of another motion vector in the list candidate motion vectors.

10. A method for coding a current block, comprising:
partitioning the current block into sub-blocks;
identifying a first neighboring block and a second neighboring block of the current block; and
for each sub-block of at least some of the sub-blocks, obtaining a respective prediction block for the each sub-block by:
obtaining, based on the first neighboring block, a first motion vector using a subblock-based temporal motion vector prediction mode;
obtaining, based on the second neighboring block, a second motion vector using the subblock-based temporal motion vector prediction mode; and
obtaining the respective prediction block for the sub-block based on the first motion vector and the second motion vector.

11. The method of claim 10, wherein the first neighboring block and the second neighboring block are selected from a predefined list of spatially neighboring available blocks.

12. The method of claim 11, wherein the first neighboring block is a bottom-left neighboring block of the current block, and wherein the second neighboring block is a top-right neighbor of the current block.

13. The method of claim 10, wherein identifying the first neighboring block and the second neighboring block of the current block comprises:
decoding, from a compressed bitstream, an indication of at least one of the first neighboring block or the second neighboring block.

14. The method of claim 10, wherein obtaining the respective prediction block for the each sub-block based on the first motion vector and the second motion vector comprises:
obtaining a motion vector that is a weighted combination of the first motion vector and the second motion vector; and
obtaining the respective prediction block using the motion vector.

15. The method of claim 14, wherein a weighting of the first motion vector and the second motion vector is based on respective distances of the each sub-block to the first neighboring block and to the second neighboring block.

16. The method of claim 10, wherein obtaining the respective prediction block for the each sub-block based on the first motion vector and the second motion vector comprises:
obtaining a first prediction block based on the first motion vector;
obtaining a second prediction block based on the second motion vector; and
obtaining the respective prediction block as a weighted combination of the first prediction block and the second prediction block.

17. The method of claim 16, wherein a weighting of the first prediction block and the second prediction block is based on respective distances of the each sub-block to the first neighboring block and to the second neighboring block.

18. A device, comprising:
a processor that is configured to perform the method of claim 1.

19. A device, comprising:
a memory; and
a processor, the processor configured to execute instructions stored in the memory to perform the method of claim 10.

20. (canceled)

21. A non-transitory computer-readable storage medium having stored thereon an encoded bitstream, wherein the encoded bitstream is configured for decoding by the method of claim 1.
